(19) United States
(12) Patent Application Publication
(10) Pub. No.: US 2007/0041061 A1
(43) Pub. Date: Feb. 22, 2007

(54) Image scanner with a light source for starting a cold cathode fluorescent tube

(75) Inventors: Kung-Cho Sheng, Taipei (TW); Shyh-Hong Wu, Taipei (TW)

Correspondence Address: BERKELEY LAW & TECHNOLOGY GROUP, 1700NW 167TH PLACE, SUITE 240, BEAVERTON, OR, 97006, US

(73) Assignee: Primax Electronics Ltd.

(21) Appl. No.: 11/224,467

(22) Filed: Sep. 12, 2005

(30) Foreign Application Priority Data
Aug. 19, 2005 (TW) 094128360

(51) Int. Cl. H04N 1/46

(52) U.S. Cl. 358/507

(57) ABSTRACT

An image scanner with a light source for starting a cold cathode fluorescent tube comprising a cold cathode tube for generating light projected on a document, a light source installed around one end of the cold cathode tube, and a control circuit connected to the cold cathode tube and the light source. The tube is illuminated by the light source before it is started to smoothly start in a dark environment.

### FIELD OF THE INVENTION

The present invention relates to an image scanner, particularly to an image scanner with a light source for starting a cold cathode fluorescent tube.

### BACKGROUND OF THE INVENTION

Cold cathode fluorescent tube (CCFT) is popularly used in image scanners as a scanning light source.

The inner surface of cold cathode fluorescent tube is coated with fluorescent material and is stricken by electrons which are excited by a starting voltage provided by a tube inverter in order to emit light.

As the scanner resolution is increasing, higher illumination intensity is also required. It is possible that the tube can't be started under some circumstances.

It is found that tubes of high resolution scanners, such as 3200 dpi and 4800 dpi, can not be started in a dark environment. Because after the tube is turned off, the fluorescent material inside the tube can save energy for next starting. However, when scanners haven't been used for a long time, the saved energy of the tube will decline. Moreover, the high resolution scanners require higher illumination intensity, so the tube need higher energy to start.

### SUMMARY OF THE INVENTION

It is an object of the present invention to provide an image scanner with a light source for starting a cold cathode fluorescent tube for providing the tube with starting energy to smoothly start the tube.

The present invention provides an image scanner with a light source for starting a cold cathode fluorescent tube, for generating image signals of a document, comprising:

a cold cathode tube for generating light projected on the document, characteristic in that the image scanner further comprising:

a light source installed around one end of the cold cathode tube; and

a control circuit connected to the cold cathode tube and the light source, which turns on the light source when the image scanner is powered on and turns on the cold cathode tube for scanning after the light source is turned off.

In a preferred embodiment, the light source is a light emitting diode (LED).

The above object and advantage of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating an image scanner according to the present invention.

### DETAILED DESCRIPTION OF THE PREFERRED EMBODIMENT

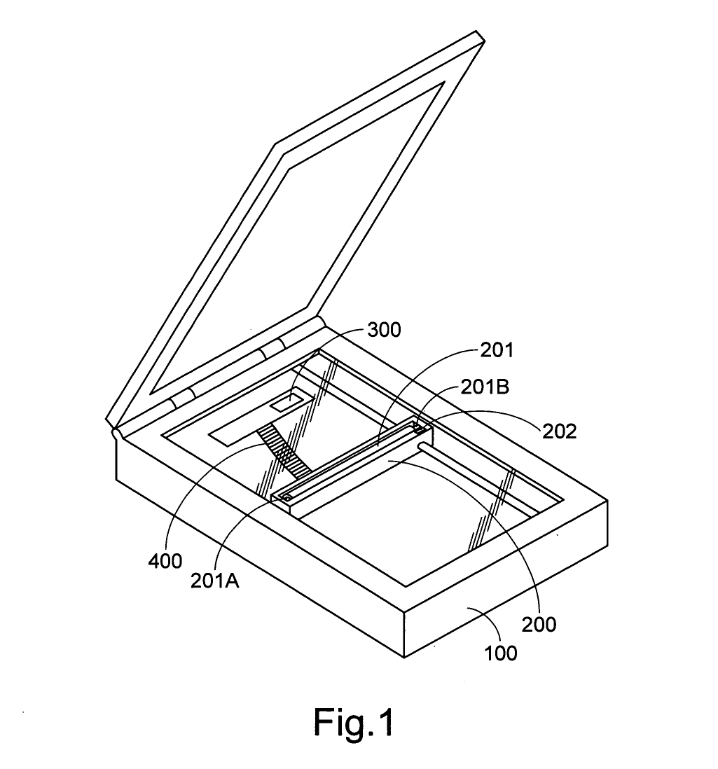

Please refer to FIG. 1, it is a preferred embodiment of this invention. FIG. 1 shows an image scanner 100, a scanning module 201, a cold cathode fluorescent tube 201, a light source 202 such as light emitting diode (LED) or other sources which can generate light, a control circuit 300 and a bus 400.

Scanning module 200 is installed inside the scanner 100 and connected to the control circuit 300 via bus 400.

When scanner 100 is powered on, the control circuit 300 turns on the LED 202 to generate light. After a period of time, the LED 202 is turned off and the cold cathode fluorescent tube 201 is started. Because tube 201 was illuminated by LED 202 and saved some energy therein before it is started, the tube 201 can be started smoothly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An image scanner with a light source for starting a cold cathode fluorescent tube, for generating image signals of a document, comprising:
a cold cathode tube for generating light projected on the document, characteristic in that the image scanner further comprising:
a light source installed around one end of the cold cathode tube; and
a control circuit connected to the cold cathode tube and the light source, which turns on the light source when the image scanner is powered on and turns on the cold cathode tube for scanning after the light source is turned off.

2. The image scanner as recited in claim 1, wherein the light source is a light emitting diode (LED).
